(19) United States
(12) Patent Application Publication
(10) Pub. No.: US 2010/0062847 A1
(43) Pub. Date: Mar. 11, 2010

(54) Electronic gaming system and method

(75) Inventors: Chantal Moore, Kent (GB); Ryan Hunt, Seattle, WA (US); Erki Esken, Kuusalu (EE)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Skype Limited, Dublin (IE)

(21) Appl. No.: 12/584,569

(22) Filed: Sep. 8, 2009

(30) Foreign Application Priority Data
Sep. 9, 2008 (GB) 0816493.1

(51) Int. Cl. A63F 13/00; A63F 9/24

(52) U.S. Cl. 463/30; 463/43

(57) ABSTRACT

A games system and method, the system comprising: a storage reader for reading a game application from a storage medium; a memory storing a communications client application; a network interface for receiving data from a remote user via a packet-based communication network; and processing apparatus arranged to execute the game application and the client application. The communication client is programmed to establish bidirectional video communications via the network interface and packet-based communication network, including receiving video data from a remote user. The game application comprises image recognition software programmed to receive the video data from the client application, recognise a predetermined image element in the received video data, and track the motion of that element to generate motion tracking data. The game application further comprises game logic programmed to control aspects of the game based on the motion tracking data.

### FIELD OF THE INVENTION

The present invention relates to games systems for playing electronic games with the involvement of a remote user.

### BACKGROUND

Computer games can be played on dedicated games consoles, personal computers, or even on other terminals such as mobile phones or PDAs (personal digital assistants). Although a “dedicated” games console may nowadays perform many of the same functions as a personal computer or other general purpose computing terminal, the console is still distinct in that it will typically be configured to have a default mode of operation as a games system. Furthermore, a home games console will also have a television output for outputting the game images to a television set (although a portable games console may have a built in screen).

Computer games have been around for many years, but in more recent years developers have been increasingly realising the potential for games that involve remote users via communication networks such as the Internet, even on games consoles through which such networks had not previously been accessible.

However, there is a problem with such remote game-play in that the degree of interaction of the remote user is limited. Hence the remote user may not feel as involved or “immersed” as if physically present with another player, but on the other hand it may not be possible to meet in person if the players are friends living at distance or such like. Therefore it would be advantageous to increase the degree of interactivity in remote gaming.

### SUMMARY

The inventors have recognised the potential for combining two otherwise diverse techniques together with a computer game to improve the degree of interaction of a remote user: that is, firstly to incorporate a video communication client into a games system to allow the user to establish a bidirectional video call via a packet-based communications network, and secondly to combine this with image recognition and tracking software so that the remote user's actions can be used to control the game.

Therefore according to one aspect of the present invention, there is provided games system comprising: a storage reader for reading a game application from a storage medium; a memory storing a communications client application; a network interface for receiving data from a remote user via a packet-based communication network; and processing apparatus coupled to said storage reader, memory and network interface, the processing apparatus being arranged to execute the game application and the client application; wherein the communication client is programmed to establish bidirectional video communications via said network interface and packet-based communication network, including receiving video data from a remote user; wherein the game application comprises image recognition software programmed to receive said video data from the client application, recognise a predetermined image element in the received video data, and track the motion of said element to generate motion tracking data; and wherein the game application further comprises game logic programmed to control aspects of the game based on said motion tracking data.

Thus physical motions enacted by the remote user can be incorporated into the game-play, advantageously increasing the degree of interactivity of the remote user and so making them feel more immersed in the game.

In embodiments, the games system is a games console having a default mode of operation as a games system. The games console may comprise a television output unit operable to output game images to a television set for display.

The image element may comprise a predetermined bodily member of the remote user, and the image recognition software may be programmed to recognise the predetermined bodily member in the received video data and track the motion of said bodily member to generate said motion tracking data.

The image element may comprise a predetermined implement to be held about the person of the remote user, and the image recognition software may be programmed to recognise the predetermined implement in the received video data and track the motion of said implement to generate said motion tracking data.

The communication client may be programmed to establish said bidirectional video communications via a peer-to-peer connection in said packet-based communication network. The communication client may be programmed to establish said bidirectional video communications via the Internet.

According to another aspect of the invention, there is provided a method of controlling a computer game, the method comprising: establishing bidirectional video communications via a packet-based communication network, including receiving video data from a remote user over said network; and executing a game application; wherein the execution of the game application comprises executing image recognition software to recognise a predetermined image element in the received video data and track the motion of said element to generate motion tracking data; and wherein the execution of the game application comprises executing game logic to control aspects of the game based on said motion tracking data.

According to another aspect of the present invention, there is provided a computer program product comprising code which when executed will perform a method according to the present invention.

### BRIEF DESCRIPTION OF THE DRAWINGS

For a better understanding of the present invention and to show how it may be put into effect, reference will now be made by way of example to the following drawings in which:

FIG. 1 is a schematic block diagram of an electronic gaming system,

FIG. 2 is a schematic diagram of a communication system,

FIG. 3 is a schematic representation of a series of captured images, and

FIG. 4 is a flow chart showing the operation of a game.

### DETAILED DESCRIPTION OF PREFERRED EMBODIMENTS

Packet-based communication systems allow the user of a terminal to communicate across a computer network such as the Internet. Packet-based communication systems include voice over internet protocol (“VoIP”) or video-over-IP communication systems. These systems are beneficial to the user as they are often of significantly lower cost than fixed line or mobile networks. This may particularly be the case for long-distance communication. To use a VoIP or video-over-IP system, the user must execute client software on their device. The client software provides the voice and video IP connections as well as other functions such as registration and authentication. In addition to voice and video communication, the client may also provide further features such as instant messaging (“IM” or “chat” messaging), SMS messaging, and voicemail.

One type of packet-based communication system uses a peer-to-peer (“P2P”) topology built on proprietary protocols. To enable access to a peer-to-peer system, the user must execute P2P client software provided by a P2P software provider on their terminal, and register with the P2P system. When the user registers with the P2P system the client software is provided with a digital certificate from a server. Once the client software has been provided with the certificate, communication can subsequently be set up and routed between users of the P2P system without the further use of a server. In particular, the users can establish their own communication routes through the P2P system based on the exchange of one or more digital certificates (or user identity certificates, “UIC”), which enable access to the P2P system. The exchange of the digital certificates between users provides proof of the users' identities and that they are suitably authorised and authenticated in the P2P system. Therefore, the presentation of digital certificates provides trust in the identity of the user. It is therefore a characteristic of peer-to-peer communication that the communication is not routed using a server but directly from end-user to end-user. Further details on such a P2P system are disclosed in WO 2005/009019.

According to a preferred embodiment of the present invention, a communication client is embedded into a games system so as to enable a user to make live, bidirectional, packet-based video calls from the games system. The client application is in the form of software stored in a memory and arranged for execution on a central processing unit (CPU), the memory and CPU being parts of the games system integrated together into a single appliance, and hence sold together as a single product, in a single casing optionally with external peripherals such as game controllers. The games system product is preferably a “dedicated” or specialised games console, meaning at least that it has a default mode of operation as a games system.

A number of image recognition algorithms have also been developed in recent years, including those to recognise and track certain predetermined image elements in moving video images. For example, it may be possible for image recognition software to recognise facial features, other body parts such as hands or limbs, inanimate item, or distinct markings placed on such items or articles of clothing. According to the preferred embodiment of the invention, the game to be loaded and executed on the games system comprises image recognition software programmed to receive video from a remote user via the video call established by the embedded client, track the motion of an element in that video, and use the tracked motion as an input in order to involve the remote user in the game.

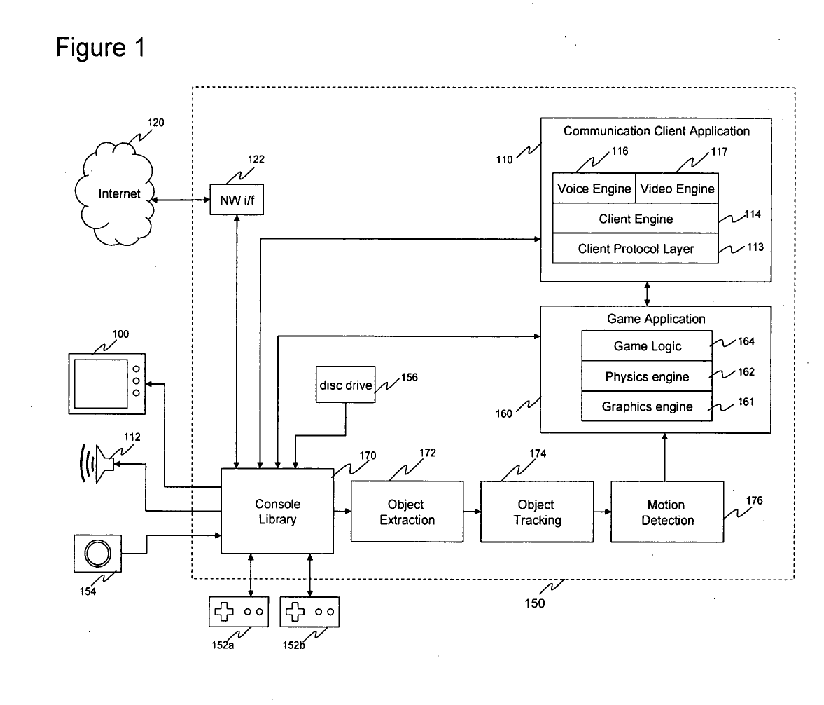

Reference is now made to FIG. 1, which is a schematic block diagram showing functional blocks of a games system 150 and connected peripherals. The games system 150 comprises a network interface 122 for connecting to the Internet 120. This network interface could be a built-in modem, or a wired or wireless interface to an external modem. The games console also comprises a storage reader, preferably a storage module reader with storage module receptacle for receiving and reading removable storage modules. The storage module reader is preferably in the form of a disc drive 156 for reading CDs, DVDs and/or other types of optical disc received via an appropriate slot or tray.

The game system 150 further comprises a console library 170, a video object extraction block 172, a video object tracking block 174, a motion detection block 176, a game application 160, and a communication client application 110. Each of these blocks is preferably a software element stored on a memory and arranged to be executed on a processing apparatus of the games system 150. The processing apparatus (not shown) comprises at least one central processing unit (CPUs), and may comprise more than one CPU for example in an arrangement of a host CPU and one or more dedicated digital signal processors (DSPs) or a multi-core arrangement. The memory (also not shown) may be of a number of different types and the above software elements may be stored in the same memory or in different memories of the same or different types. For example, the communication client 110 may be installed on an internal hard-drive or flash memory of the games system 150, and the game application 160 may be stored on an optical disc and loaded via the disc drive 156 for execution. Alternatively, the game application could be copied from the optical disc onto the hard drive or flash memory of the game system 150, or downloaded from a server via the network interface 122 and Internet 120. In other embodiments, the client application 110 and/or game application 160 could be stored on an external hard drive or flash memory.

Given the different possible types of memory, note therefore that the game system's storage readers need not necessarily include only a storage module reader such as an optical disc drive, but could also include the reading mechanism of a hard drive, the read circuitry of a flash memory, or suitable software for accessing a server via the network interface 122.

The console library 170 is a basic system library which takes care of low level functions including input and output functions. The console library 170 is preferably stored on a memory internal to the games system 150, e.g. on a hard drive, flash memory or read-only memory (ROM).

The object extraction block 172, object tracking block 174 and motion detection block 176 may be common software elements stored on an internal hard drive, flash memory or ROM of the games system 150 such that they can be used by a plurality of different game applications 160. Alternatively, although shown as being separate, they could be part of a particular game application 160 (being loaded from a disc or server or copied to the hard drive or flash as appropriate to that game application 160).

The console library 170 is operatively coupled to the screen of a television set 100 via a television output port (not shown) of the games system 150. The console library is also operatively coupled to a loudspeaker 112, which although shown separately is preferably housed within the television set 100 and coupled to the console library 170 via the television output port. Alternatively another audio output source could be used such as headphones or a connection to a separate stereo or surround-sound system.

In order to receive user inputs from a local user of the games system 150, the console library 170 is operatively coupled to one or more game controllers 152 via one or more respective controller input ports (not shown) of the games system 150. These could comprise a more traditional arrangement of user controls such as a directional control pad or stick with accompanying buttons, and/or other types of user inputs such as one or more accelerometers an/or light sensors such that physical movement of the controller 152 provides an input from the user. In embodiments, the console library 170 may also be arranged to be able to receive audio inputs from a microphone in the controller 152 or provide outputs to a vibrator or speaker housed in the controller 152, again via the controller port. Alternatively, a separate microphone input could be provided.

In order to receive video data from the local user of the games system 150, the console library 170 is operatively coupled to a digital video camera 154, either a webcam or digital camera with video capability, via a camera input port or general purpose input port (not shown).

In order to load game applications or other software from discs, the console library 170 is operatively coupled to the disc drive 156.

Further, the console library 170 is operatively coupled to the network interface 122 so that it can send and receive data via the Internet 120 or other packet-based network.

The console library 170 is operatively coupled to the game application 160, thus enabling inputs and outputs to be communicated between the game application 160 and the various I/O devices such as the TV set 100, loudspeaker 112, controllers 152, video camera 154, disc drive 156 and network interface 122. The console library 170 is also operatively coupled to the client application 110, thus enabling inputs and outputs to be communicated between the client application 110 and the I/O devices such as the TV set 100, loudspeaker 112, controllers 152, video camera 154, disc drive 156 and network interface 122.

The console library 170 is operatively coupled to the object extraction block 172, the object extraction block 172 is in turn operatively coupled to the feature tracking block 174, the object tracking block 174 is in turn operatively coupled to the motion detection block 176, and the motion detection block 176 is in turn operatively coupled to the game application 160. The game application 160 is operatively coupled to the client application 110.

The packet-based communication client 110 embedded in the games system 150 is based around four main elements. Preferably, these four elements are software elements that are stored in memory and executed on a CPU both embedded in the TV 150. The four elements are: a client protocol layer 113, a client engine 114, a voice engine 116, and a video engine 117.

The client engine 114, voice engine 116 and video engine 117 establish and conduct bidirectional, packet-based, point-to-point (including the possibility of point-to-multipoint) communications via a packet based communication network such as the Internet 120; e.g. by establishing a peer-to-peer (P2P) connection over a peer-to-peer network implemented over the Internet 120.

The protocol layer 113 deals with the underlying protocols required for communication over Internet 120.

The client engine 114 is responsible for setting up connections to the packet-based communication system. The client engine 114 performs call set-up, authentication, encryption and connection management, as well as other functions relating to the packet-based communication system such as firewall traversal, presence state updating, and contact list management.

The voice engine 116 is responsible for encoding of voice signals input to the games system 150 as VoIP packets for transmission in streams over the Internet 120 and the decoding of VoIP packets received in streams from the Internet 120 for presentation as audio information to the user of the TV 150. The voice signals may be provided by the local user from a microphone in the controller 152 or separate microphone via the console library 170. The audio output may be output to the loudspeaker 170 via the console library 170.

The video engine 117 is responsible for the encoding of video signals input to the games system 150 as packets for transmission in streams over the internet 120 in a video call, and the decoding of video packets received in streams of video calls for presentation as video images to the TV set 100. The input video signals may be provided by the local user from the video camera 154 via the console library 170. The output video may be output to the TV set 100 via the console library 170.

The game application 160 comprises game logic 164, a physics engine 162 and a graphics engine 161. The game logic 164 is responsible for receiving inputs from users and processing those inputs according to the rules of the game to determine game events. The physics engine 160 takes the results of the game logic 162 to determine actual character and object movements according to the physics of the game (if any), and may feed back these movements to the game logic 164 for further processing according to the game rules to determine further game events. The graphics engine 161 takes the movements calculated by the physics engine 162 and generates the actual graphics to display on the screen 100 accordingly.

Preferably, the game application 160 and client application 110 can interact with one another so that voice and/or video inputs from the client 110 can be incorporated into the game and game events can be used to affect or control voice and/or communications over the packet-based communication system.

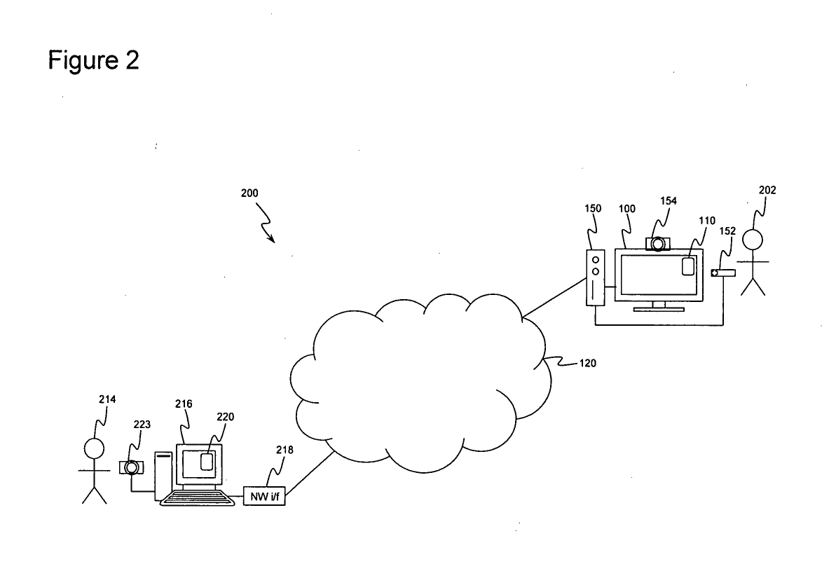

In order to describe the operation of the games system 150 with the packet-based communication system, and particularly the operation of the game application 160 with the communication client 110, reference is now made to FIG. 2, which illustrates the use of the games system 150 in a portion of an example system 200.

Note that whilst the illustrative embodiment shown in FIG. 2 is described with reference to a P2P communication system, other types of non-P2P communication system could also be used. The system 200 shown in FIG. 2 shows a first user 202 of the communication system operating a TV 100, which is shown connected to a games system 150, which is in turn connected to a network 120. Note that the communication system 200 utilises a network such as the Internet. The games system 150 is connected to the network 120 via a network interface (not shown) such as a modem, and the connection between the games system 150 and the network interface may be via a cable (wired) connection or a wireless connection.

The games system 150 is executing an embedded communication client 110. The games system 150 is arranged to receive information from and output information to the user 202. A controller 152 acts as the input device operated by the user 202 for the control of the games system 150.

The embedded communication client 110 is arranged to establish and manage voice and video calls made over the packet-based communication system using the network 120. The embedded communication client 110 is also arranged to present information to the user 202 on the screen of the TV 100 in the form of a user interface. The user interface comprises a list of contacts associated with the user 202. Each contact in the contact list has a user-defined presence status associated with it, and each of these contacts have authorised the user 202 of the client 110 to view their contact details and user-defined presence state.

The contact list for the users of the packet-based communication system is stored in a contact server (not shown in FIG. 2). When the client 110 first logs into the communication system the contact server is contacted, and the contact list is downloaded to the client 110. This allows the user to log into the communication system from any terminal and still access the same contact list. The contact server is also used to store a mood message (a short user-defined text-based status that is shared with all users in the contact list) and a picture selected to represent the user (known as an avatar). This information can be downloaded to the client 110, and allows this information to be consistent for the user when logging on from different terminals. The client 110 also periodically communicates with the contact server in order to obtain any changes to the information on the contacts in the contact list, or to update the stored contact list with any new contacts that have been added.

Also connected to the network 120 is a second user 214. In the illustrative example shown in FIG. 2, the user 214 is operating a user terminal 216 in the form of a personal computer (“PC”) (including for example Windows™, Mac OS™ and Linux™ PCs). Note that in alternative embodiments, other types of user terminal can also be connected to the packet-based communication system. For example, the second user's terminal 216 could be a personal digital assistant (“PDA”), a mobile phone, or another games system similar to the first user's games system 150 or otherwise. In a preferred embodiment of the invention the user terminal 216 comprises a display such as a screen and an input device such as a keyboard, mouse, joystick and/or touch-screen. The user device 216 is connected to the network 120 via a network interface 218 such as a modem.

Note that in alternative embodiments, the user terminal 216 can connect to the communication network 120 via additional intermediate networks not shown in FIG. 2. For example, if the user terminal 216 is a mobile device, then it can connect to the communication network 120 via a mobile network (for example a GSM or UMTS network).

The user terminal 216 is running a communication client 220, provided by the software provider. The communication client 220 is a software program executed on a local processor in the user terminal 216 comprising similar elements to the embedded communication client 110. The communication client 220 enables the user terminal 216 to connect to the packet-based communication system. The user terminal 216 is also connected to a handset 222, which comprises a speaker and microphone to enable the user to listen and speak in a voice call. The microphone and speaker does not necessarily have to be in the form of a traditional telephone handset, but can be in the form of a headphone or earphone with an integrated microphone, as a separate loudspeaker and microphone independently connected to the user terminal 216, or integrated into the user terminal 216 itself. The user terminal 216 is also connected to a video camera 223, such as a webcam, which enables video images from the user terminal 216 to be sent in a video call.

Presuming that the first user 202 is listed in the contact list of the client 220 presented to second user 214, then the second user 214 can initiate a video call to the first user 202 over the communication network 120. This video call can be incorporated into a game at the games system 150.

The video call set-up is performed using proprietary protocols, and the route over the network 120 between the calling user and called user is determined by the peer-to-peer system without the use of servers. Following authentication through the presentation of digital certificates (to prove that the users are genuine subscribers of the communication system—described in more detail in WO 2005/009019), the call can be established.

The user 202 can select to answer the incoming video call by pressing a key on the controller 152. When the video call is established with the second user 214, voice and video packets from the user terminal 216 begin to be received at the communication client 110.

In the case of video packets, video images are captured by the video camera 223, and the client 220 executed on user terminal 216 encodes the video signals into video packets and transmits them across the network 120 to the games system 150. The video packets are received at the console library 170 (see FIG. 1) and provided to the client protocol layer 113. The packets are processed by the client engine 114 and video data is passed to the video engine 117. The video engine 117 decodes the video data to produce live video images from the video camera 223 at the remote user terminal 216.

The video images are called “live” in the sense that they reflect the real-time input to the remote video camera 223. However, it will be understood that this is only an approximation in that transmission and processing delays in both clients 220 and 110, and over the network 120 will result in the video images at the games system 150 being displayed at the TV 100 with a time-delay relative to when the images are input to the remote video camera 223. There may also be a certain degree of jitter depending on delays.

In parallel with the processing of video packets, voice packets are also handled to provide the audio component of the video call. In the case of voice packets, when the second user 214 talks into handset 222, the client 220 executed on user terminal 216 encodes the audio signals into VoIP packets and transmits them across the network 120 to the games system 150. The VoIP packets are received at the client protocol layer 113 (via the console library), provided to the client engine 114 and passed to the voice engine 116. The voice engine 116 decodes the VoIP packets to produce audio information. The audio information is passed to the console library 170 for output via the speaker 112.

The live video images decoded by the video engine 117 are provided to the to the console library 170 for display to the user 202 on the TV 100.

The operation of a game involving remote video image recognition and tracking is now described with reference to FIGS. 1, 2 and 3.

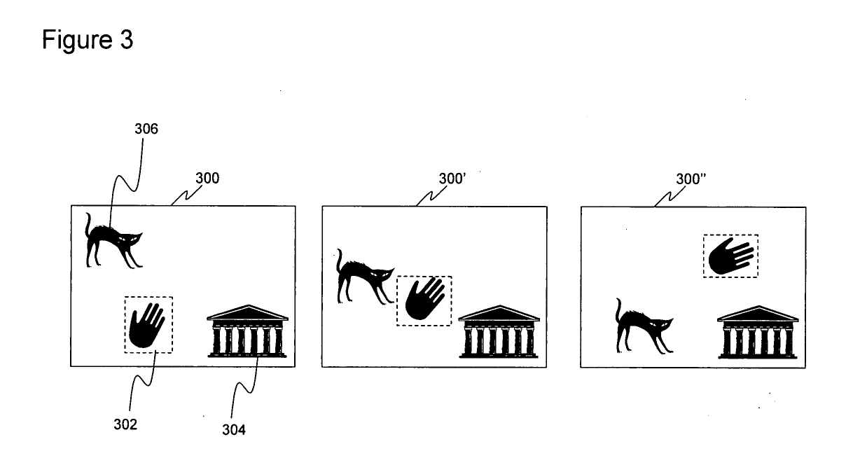

To begin, the first user 214 loads and runs the game application 160 on his games system 150. The second user also loads and runs any required games application on his own terminal 216. The games application 160 contains code which when executed controls the client application 110 to establish a video call with the second user 214 in the manner described above. During the call, the second user's video camera 223 captures a moving video image 300 over a period of time, which is transmitted over the network 120 to the games system 150. FIG. 3 shows schematically an example video image as received at the games system 150 from the second user's era 223 at a series of instances in time 300, 300′ and 300″. For the sake of example, these include a moving video object 302 to be recognised and tracked, some stationary background scenery 304, and another moving object 306 which is to be ignored.

The video object 302 to be recognised is in this example a hand of the second user 214. However, in other embodiments the object 302 could be another bodily member such as a limb or facial feature; or the remote user 214 could be provided with a wand, baton and/or article of clothing having bold, distinct markings. The video object in question could be any video image element suitable for recognition by image recognition software.

The console library receives the moving video image 300, 300′, 300″ and supplies this to the object extraction block 172. The object extraction block 172 processes the data from the camera, e.g. using vision algorithms that are trained to recognise predefined shapes. The object extraction block 172 thus recognises the required video object and generates information on its location, whilst at the same time filtering out unwanted background scenery 304 or other, unwanted objects 306. The object extraction block 172 may also receive an input from the game application 160 so that the game application 160 can control which feature the object extraction block 172 should extract from the video stream, for example face, mouth etc.

The object extraction block 172 outputs the location in the image of the extracted object to the object tracking block 174. The object tracking block 174 is arranged to track the locations of the object identified by the object extraction block 172 over time, e.g. as in the series of instances in time 300, 300′, 300″ shown in FIG. 3. The coordinates of the locations are output to the motion detection block 176.

The motion detection block 176 is arranged to calculate the direction, speed and/or acceleration of the feature by determining the change in coordinates over time. The motion detector 176 outputs this motion information representing the extracted features to the game application 160.

Thus the described system allows a video stream from a remote user 214 to control a computer game, with a feature such as the remote user's hand or face may be extracted from the video stream and tracked such that the motion of the feature may be determined and used as an input to the game. For example, the motion of a user's hand in the video stream may be used to catch a ball, throw a Frisbee, etc.

In a preferred embodiment of the invention the console is connected to another console 216 via the internet in a video call associated with the game, the other console 216 also running a similar game application. The video communicated in the video call may then be incorporated into the game by displaying the video of the second user 214 to the first user 202 during the game, and/or vice versa. This may be conditional on certain game events, according to the game logic.

In such embodiments, the object extraction, object tracking and/or motion information described above could alternatively be calculated at the terminal at which the video captured, i.e. remotely from the terminal at which it is used to control the game. This data could then be transmitted between the consoles together with the video data stream. So for example, the second user 214 could run a game application on his terminal 216 which performs the object extraction, object tracking and generation of motion information based on the video captured at that terminal 216; and then the second user's client application 220 could transmit the generated motion information to the first user's game system 150 over the packet-based communication system, preferably along the video itself, so that the first user's game application 160 could use that remotely generated motion information to control the game.

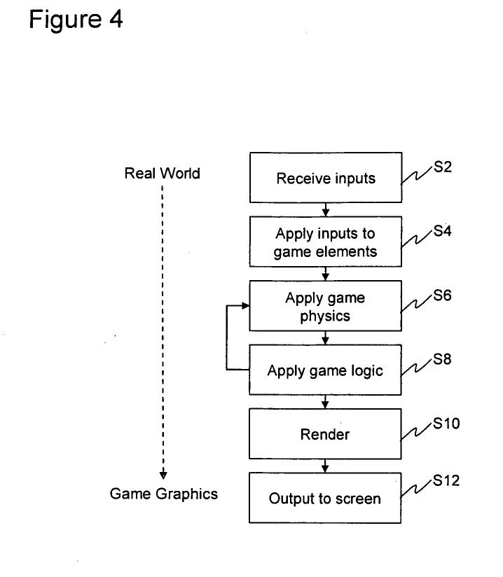

A method of running a game is now described in relation to the flow chart of FIG. 4.

In a first step S2 the game receives inputs which describe the motion of the extracted features. Then at step S4 the game logic 164 applies the inputs to the game elements representing of the current state of the game. The effect of inputs is determined by the current state of the game, will have different effect in menu screens or different game views.

In a next step S6 the game physics are calculated by the physics engine 162, for example how far a ball should be thrown given the application of the inputs. At step S8 any motion calculated by the physics engine may be returned to the game logic 164 for further application to the game elements representing the state of the game.

At step S10, the graphics engine 161 receives an input from the game logic 162 and/or physic engine 164 about the game world. A renderer in the graphics engine controls what graphics should be written to a frame buffer for output to the screen 100. These graphics may represent the game element that is being controlled by the user (e.g. a ball or Frisbee). At step S12 the graphics are output to the screen 100.

Video data 300 from which the feature is extracted may also be written to the frame buffer and output to the screen 100. Thus a video image of the remote user carrying out the corresponding action may be incorporated into the game. For example, a video of the user 214 performing a throwing action may be combined with the image of the ball on the screen 100 of the first user 202.

While this invention has been particularly shown and described with reference to preferred embodiments, it will be understood to those skilled in the art that various changes in form and detail may be made without departing from the scope of the invention as defined by the appended claims.

1. A games system comprising:
a storage reader for reading a game application from a storage medium;
a memory storing a communications client application;
a network interface for receiving data from a remote user via a packet-based communication network; and
processing apparatus coupled to said storage reader, memory and network interface, the processing apparatus being arranged to execute the game application and the client application;
wherein the communication client is programmed to establish bidirectional video communications via said network interface and packet-based communication network, including receiving video data from a remote user;
wherein the game application comprises image recognition software programmed to receive said video data from the client application, recognise a predetermined image element in the received video data, and track the motion of said element to generate motion tracking data; and
wherein the game application further comprises game logic programmed to control aspects of the game based on said motion tracking data.

2. The games system of claim 1, wherein the games system is a games console having a default mode of operation as a games system.

3. The games system of claim 2, wherein the games console comprises a television output unit operable to output game images to a television set for display.

4. The games system of claim 1, wherein the image element comprises a predetermined bodily member of the remote user, the image recognition software being programmed to recognise the predetermined bodily member in the received video data and track the motion of said bodily member to generate said motion tracking data.

5. The games system of claim 1, wherein the image element comprises a predetermined implement to be held about the person of the remote user, the image recognition software being programmed to recognise the predetermined implement in the received video data and track the motion of said implement to generate said motion tracking data.

6. The games system of claim 1 wherein the communication client is programmed to establish said bidirectional video communications via a peer-to-peer connection in said packet-based communication network.

7. The game system of claim 1, wherein the communication client is programmed to establish said bidirectional video communications via the Internet.

8. A method of controlling a computer game, the method comprising:
establishing bidirectional video communications via a packet-based communication network, including receiving video data from a remote user over said network; and
executing a game application;
wherein the execution of the game application comprises executing image recognition software to recognise a predetermined image element in the received video data and track the motion of said element to generate motion tracking data; and
wherein the execution of the game application comprises executing game logic to control aspects of the game based on said motion tracking data.

9. The method of claim 8, wherein the game application is executed on a games console, and the method comprises operating the console in a default mode of operation as a games system.

10. The method of claim 9, wherein the games console comprises a television output unit, and the method comprises outputting game images via the television output unit to a television set for display.

11. The method of claim 8, wherein the image element comprises a predetermined bodily member of the remote user, said recognition comprises recognising the predetermined bodily member in the received video data, and said tracking comprises tracking the motion of said bodily member to generate said motion tracking data.

12. The method of claim 8, wherein the image element comprises a predetermined implement to be held about the person of the remote user, said recognition comprises recognising the predetermined implement in the received video data, and said tracking comprises tracking the motion of said implement to generate said motion tracking data.

13. The method of claim 8, wherein said establishment of said bidirectional video communications comprises establishing the bidirectional communications via a peer-to-peer connection in said packet-based communication network.

14. The method of claim 8, wherein said establishment of said bidirectional video communications comprises establishing the bidirectional communications via the Internet.

15. A computer program product comprising code which when executed on a processor will perform the method of:
establishing bidirectional video communications via a packet-based communication network, including receiving video data from a remote user over said network;
executing a game application;
wherein the execution of the game application comprises executing image recognition software to recognise a predetermined image element in the received video data and track the motion of said element to generate motion tracking data; and
wherein the execution of the game application comprises executing game logic to control aspects of the game based on said motion tracking data.
